(19) United States
(12) Patent Application Publication
(10) Pub. No.: US 2025/0164365 A1
(43) Pub. Date: May 22, 2025

(54) MICRO EXTENSION SPRING INSPECTION DEVICE

(71) Applicant: Honeywell Federal Manufacturing & Technologies, LLC, Kansas City, MO (US)

(72) Inventors: Jason David Fuller, Kansas City, MO (US); Jeffrey J. Pendleton, Kansas City, MO (US)

(21) Appl. No.: 18/948,620

(22) Filed: Nov. 15, 2024

Related U.S. Application Data
(60) Provisional application No. 63/599,763, filed on Nov. 16, 2023.

(51) Int. Cl. G01N 3/08

(52) U.S. Cl. CPC G01N 3/08; G01N 2203/0017; G01N 2203/0292

(57) ABSTRACT

An inspection device for measuring micro spring tension. The inspection device includes a guideway and a linearly slidable plate slidably positioned within the guideway and having an elongated opening formed therethrough. The inspection device further includes a load cell fixed relative to the guideway and extending through the elongated opening of the linearly slidable plate. The micro spring is attached between a slide spring attachment fixed to the linearly slidable plate and a load cell spring attachment fixed to the load cell. Finally, the inspection device includes a linear measurement indicator shaft and one or more processors for outputting to a user interface or an external system a load associated with signals from the load cell and/or a distance associated with signals from the linear measurement indicator shaft.

### CROSS-REFERENCE TO RELATED APPLICATIONS

The current patent application is a non-provisional utility patent application which claims priority benefit, with regard to all common subject matter, of earlier-filed U.S. Provisional Application Ser. No. 63/599,763; titled “MICRO EXTENSION SPRING INSPECTION DEVICE”; and filed Nov. 16, 2023. The Provisional Application is hereby incorporated by reference, in its entirety, into the current patent application.

### STATEMENT REGARDING FEDERALLY-SPONSORED RESEARCH OR DEVELOPMENT

This invention was made with Government support under Contract No.: DE-NA-0002839 awarded by the United States Department of Energy/National Nuclear Security Administration. The Government has certain rights in the invention.

Micro springs have a size of about 0.003-0.004 inches (generally no greater than approximately 0.006 inches) in wire diameter and a mean body diameter of about 0.030-0.040 inches (generally approximately 0.050 inches or less), with overall lengths of approximately 0.125 inches to 0.25 inches (generally approximately 0.50 inches or less coil body length) in a naturally-biased position (without being pulled or stretched). The loads for such springs may generally be under 1.50 ounces, a half ounce, or in some embodiments approximately at or under 0.74 ounces. To inspect a spring, some vendors require cycling the spring a certain number of times and also measuring spring tension at predetermined spring displacements. Thus, prior art mechanisms are designed for measuring and cycling a spring per inspection requirements, but such prior art devices do not measure such small springs like micro springs with sufficient accuracy to be of much use. That is, prior art spring gauges and load cells have showed unacceptable variations in reliability, reproducibility, and repeatability studies.

Therefore, there is a need for a device for micro extension spring inspection that does not suffer from these and other deficiencies of the prior art.

### SUMMARY

The present invention includes an inspection device for measuring micro extension springs as part of an inspection process. In one or more embodiments, an inspection device for measuring micro spring tension includes a guideway, a slidable plate, a load cell, a slide spring attachment, a load cell spring attachment, a sensor, and one or more processors. The slidable plate is slidably positioned within the guideway and has an elongated opening formed therethrough, such that the slidable plate selectively slides back and forth along a single axis of movement. The load cell is fixed relative to the guideway and extends through the elongated opening of the linearly slidable plate. The slide spring attachment is fixed to the linearly slidable plate and the load cell spring attachment is fixed to the load cell and spaced a distance away from the slide spring attachment such that opposing ends of the micro spring are attachable between the slide spring attachment and the load cell spring attachment. The sensor senses movement along the single axis of the linearly slidable plate. The one or more processors receive load output from the load cell and distance output from the sensor and output (e.g., to a user interface or an external system) a load associated with the load output and/or a distance associated with the distance output.

In another embodiment, an inspection device for measuring micro spring tension includes a guideway, a linearly slidable plate slidably positioned within the guideway, a load cell fixed relative to the guideway, a slide spring attachment, a load cell spring attachment, a linear measurement indicator shaft, and one or more processors. The slidable plate may have an elongated opening formed therethrough and the load cell extends through the elongated opening of the linearly slidable plate. The slide spring attachment is fixed to the linearly slidable plate and the load cell spring attachment is fixed to the load cell. The micro spring is attachable between the slide spring attachment and the load cell spring attachment. The linear measurement indicator shaft senses relative linear movement of the linearly slidable plate or the slide spring attachment. The one or more processors receive signals from the load cell and the linear measurement indicator and output (e.g., to a user interface or an external system) a load associated with signals from the load cell and/or a distance associated with signals from the linear measurement indicator shaft.

In yet another embodiment, an inspection method for measuring micro spring tension with an inspection device includes attaching a micro spring between a linearly slidable plate and a load cell and linearly sliding the linearly slidable plate away from the load cell, thereby stretching the micro spring. The linearly slidable plate is slidable relative to a steel guideway and has an elongated opening formed through the linearly slidable plate, and the load cell is fixed relative to the guideway and extends through the elongated opening. The method may also include receiving from a linear measurement indicator shaft a measurement corresponding to an amount of relative linear movement of the linearly slidable plate and receiving from the load cell a load cell output. Finally, the method may include outputting the relative linear movement and/or the load cell output to a user interface or an external system.

This summary is intended to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in more detail below with reference to the attached drawing figures, wherein:

FIG. 1 is a perspective view of a micro extension spring inspection device constructed in accordance with embodiments of the present invention;

FIG. 2 is a magnified fragmentary view of the inspection device of FIG. 1, depicted a load cell, a detented spring attachment oriented to a known polar orientation, and a shaft of a linear measurement device, in accordance with embodiments of the present invention;

FIG. 3A is a side elevation view of the inspection device of FIG. 1;

FIG. 3B is a cross-sectional view of the inspection device of FIG. 3A taken along line 3B-3B;

FIG. 3C is a magnified fragmentary view taken from Detail 3C of FIG. 3B;

FIG. 4A is a front elevation view of the inspection device of FIG. 1;

FIG. 4B is a cross-sectional view of the inspection device of FIG. 4A taken along line 4B-4B;

FIG. 4C is a magnified fragmentary view taken from Detail 4C of FIG. 4B; and

FIG. 5 is a flow chart of a method of micro spring inspection in accordance with various embodiments of the invention described herein.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The embodiments are intended to describe aspects of the invention in sufficient detail to enable those skilled in the art to practice the invention. Other embodiments can be utilized, and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” means the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the present technology can include a variety of combinations and/or integrations of the embodiments described herein.

Embodiments of the present invention are generally directed to an inspection device for measuring micro extension springs as part of an inspection process. A micro extension spring is a spiral spring made of a resilient material such as certain types of metal and is configured to be lengthened and/or relaxed by various mechanical forces, while being resiliently biased to return to a natural state, also known as a non-lengthened and/or non-compressed state, automatically when such mechanical forces are removed. Unlike traditional springs, micro extension springs in their natural state are only approximately 0.125 inches to 0.25 inches or generally approximately 0.50 inches or less in overall length in a naturally-biased position (without being pulled or stretched). Furthermore, the micro springs may have a wire diameter of about 0.003-0.004 inches and in some embodiments a wire diameter of no greater than approximately 0.006 inches. The micro springs may also have a mean body diameter of about 0.030-0.040 inches or in some embodiments approximately 0.050 inches or less. The micro springs may be designed for loads under equal to or less than 1.50 ounces or a half ounce, or in some embodiments approximately at or under 0.75 ounces. In some embodiments, micro springs may have opposing ends formed into hooks or loops for attachment to inspection devices such as the inspection device described herein.

The inspection device is a specialized fixture/gauge to inspect micro extension spring load at a known displacement. Specifically, the inspection device may be manually adjustable and measures micro extension spring tension at predetermined micro spring displacements. Additionally or alternatively, the inspection device can control for either displacement or load in order to get the other. For example, displacement x may result in load y or alternatively providing load y can result in displacement x without departing from the scope of the technology described herein. Previously, a resource to fully inspect micro extension springs and verify the inspection methods available to them did not exist, so vendors were unable to fully, functionally inspect the micro extension springs they manufactured.

Unlike prior art mechanisms that are designed to both measure and cycle the spring, the inspection device disclosed herein may be designed for these two tasks to be split, such that the inspection device measures the spring tension at pre-determined spring displacements and then a different device is used to cycle the spring. This inspection device helps understand the load being measured at the distance the micro spring is being stretched.

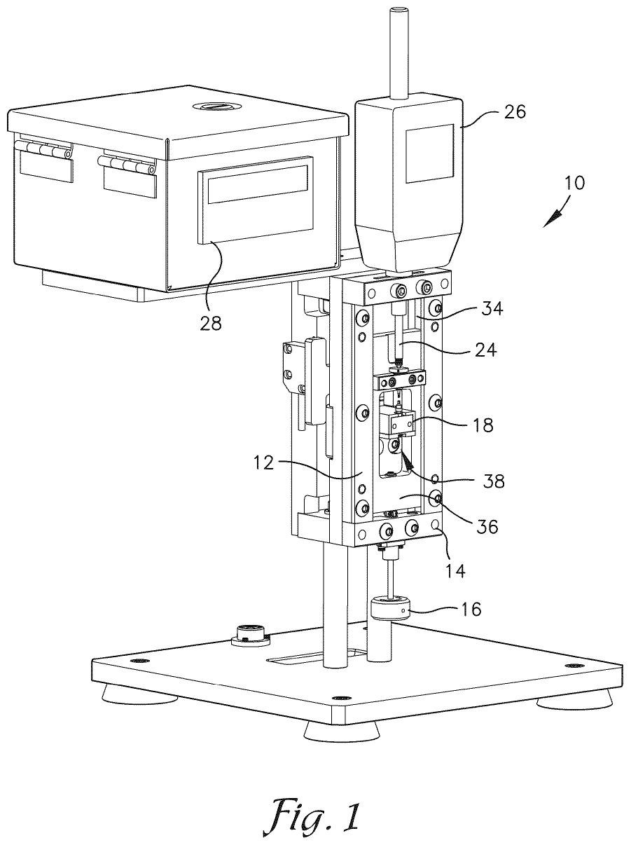

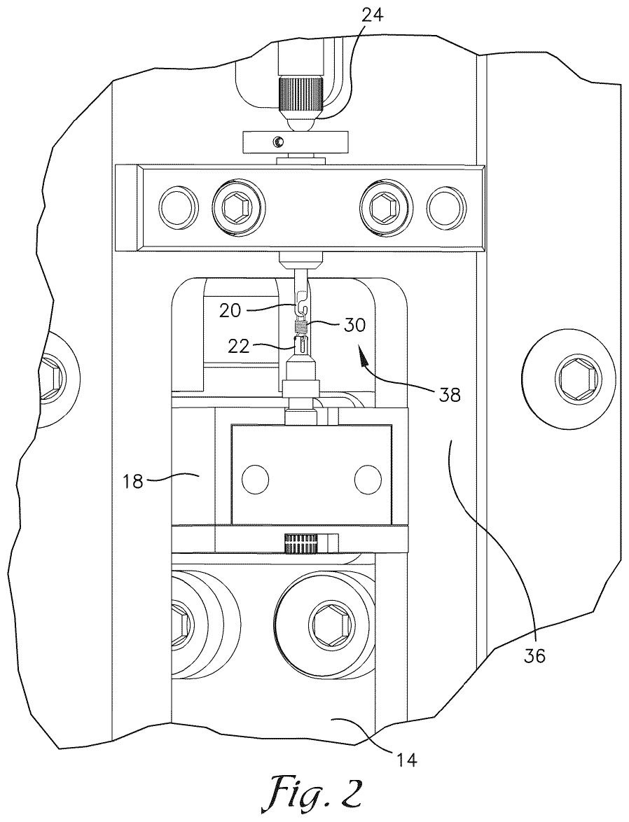

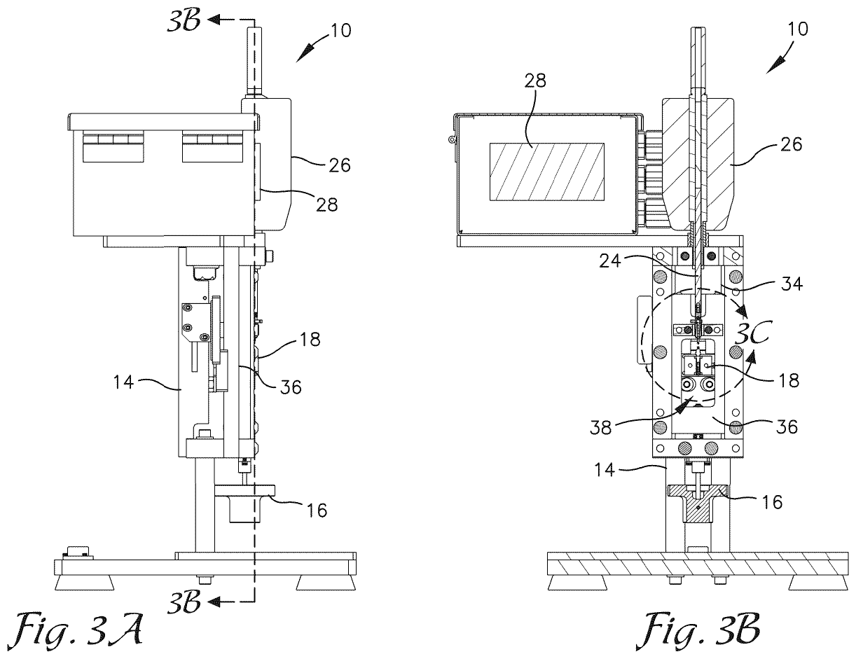

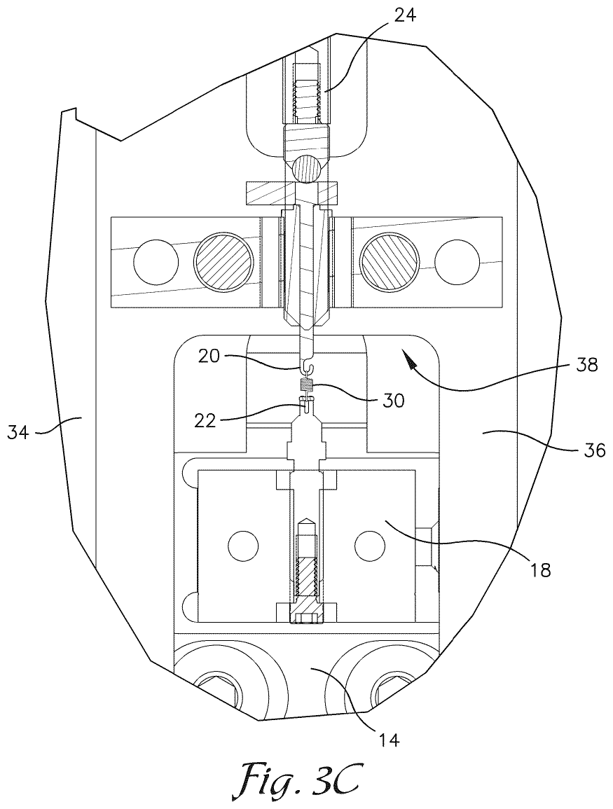

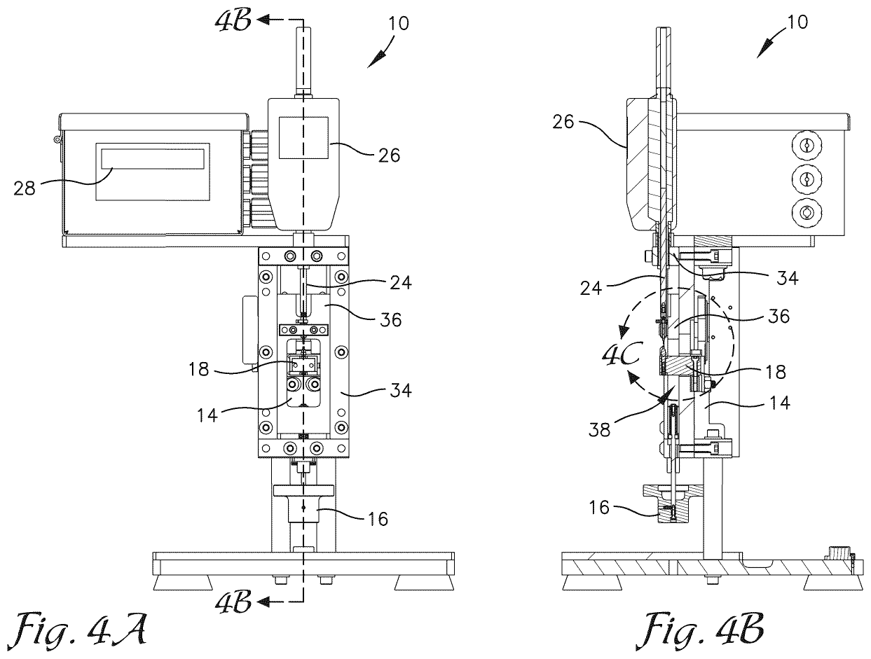

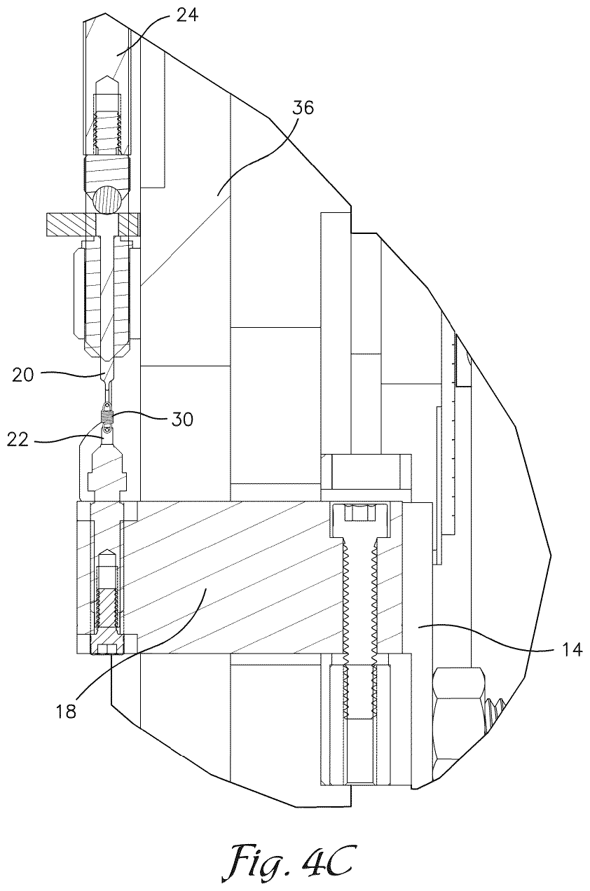

In one or more embodiments, as depicted in FIGS. 1-4C, an inspection device 10 may include a linear slide 12 (adjustable linearly in an up and down or side to side manner, for example), a fixture 14 (e.g., a frame) to which the linear slide 12 is attached, a slide position fine adjust mechanism 16, a load cell 18, a slide spring attachment 20, a load cell spring attachment 22, a linear measurement indicator shaft 24, a linear measurement indicator 26, and/or a load cell readout 28. The linear measurement indicator 26 and/or the linear measurement indicator shaft 24 associated therewith may be part of and/or alternatively may be replaced by any linear measurement device without departing from the scope of the invention described herein. Note that although the term “linear” is illustrated and associated herein with movement up and down along a single vertical axis of movement, the slidable movement may be performed back and forth along any single axis of movement, not only vertical, without departing from the scope of the technology described herein. The inspection device 10 may be configured for measuring a micro extension spring 30 as part of an inspection process.

Loads measured by the inspection device 10 may be, for example, 0 to 2 ounces with estimated displacement accuracy to within +/−0.0001″ or within an even tighter accuracy range. The fixture 14 may include or have mounted thereto a guideway 34. In one or more embodiments, the linear slide 12 includes the guideway 34 and a gib slide 36 or the like that is laterally slidable relative to the guideway 34 and/or the fixture 14. For example, the fixture 14 and/or the linear slide 12 may comprise an all-steel saddle (e.g., the guideway 34) with a steel moving carriage plate (e.g., the gib slide 36). However, in some embodiments, the steel used for these components may be replaced with another type of metal or other rigid materials. The gib slide 36 may be a linearly slidable plate having an elongated opening 38 therethrough, extending along a length of the gib slide 36 in a same direction as the linear movement of the gib slide 36 or carriage plate. The gib slide 36 can be any sort of linear slide known in the art. In some embodiments, the linear guideway 34 may be of any design in which the load cell 18 is mounted central to guiding features thereof (e.g., the elongated opening 38 described herein). For example, in some alternative embodiments, the linear guideway 34 or linear slide 12 may include a pair of guide shafts with linear bearings that flank the load cell 18.

A linear slide 12 may be designed for tight linear movement using mechanical components such as bearings and shims and lock collars to keep moving components tight to avoid guideway induced measurement hysteresis and/or lash when the gib slide 36 is moving up and down. Some components of the linear slide 12 such as the guideway's components and the gib slide 36 may be made of steel or other hardened metal that are heat treated and ground into the configuration depicted in the figures. Hardened and heat-treated metals that can be ground into a desired shape provides flatter, more squared off configurations, and allows components of the linear slide to fit together better and in tighter tolerance than machining a component can generally accomplish. The linear movement of the linear slide 12 is highly accurate and does not wiggle around much if at all when the gib slide 36 slides within the guideway 34, for example.

The slide position fine adjustment mechanism 16 may be configured to selectively linearly adjust a position of the gib slide 36 by actuation of the slide position fine adjustment mechanism. The slide position fine adjust mechanism 16 may be, for example, a threaded rod and anti-backlash nut utilized to control the position or starting position of the gib slide 36. In some embodiments, the slide position fine adjustment mechanism 16 may be connected to a bottom of the linear slide 12 and may comprise bearings in it and be connected to a handle that turns for fine linear adjustment of the gib slide 36 to accommodate for slightly different lengths of micro springs 30 or other fine tune adjusting needed during calibration. For example, there may be some preloaded bearings in the slide position fine adjustment mechanism 16 that take lash out of the inspection device 10. The slide position fine adjustment mechanism 16 may also include an anti-backlash nut and screw mechanism. This allows for fine adjustment of the gib slide 36 up and down, either before or during calibration steps described herein or during micro spring inspection steps described herein, in which the linear measurement device 26 or the linear measurement indicator shaft 24 may measure how far linearly the gib slide 36 travels. In some embodiments of the anti-backlash nut and screw, the screw may be altered to fit to the gib slide 36. A tapped hole on an end of the screw may be placed to hold a handle thereon, which handle may be turned for manual adjustment of the slide position fine adjustment mechanism 16. The screw may also be machined to have a tapped hole at one end and cut a groove at the one end to put a lock collar to keep the components from moving at undesired times such as during use for spring measurement. However, other adjustment mechanisms such as ballscrew, four bar, or the like may be used for the slide position fine adjustment mechanism 16 without departing from the scope of the technology described herein.

The load cell 18 is a high-accuracy, low-load load cell. In some embodiments, the load cell may include a smaller box inside a bigger box, with the load cell spring attachment extending through an opening in the bigger box and attaching to the smaller box. The smaller box moves by a small amount within the bigger box in response to being pulled by the micro spring when the gib slide 36 slides. The movement of the smaller box relative to the bigger box can thus be used by components of the load cell 18 to determine a load cell readout. The load cell readout may be indicative of how hard the micro spring is pulling in response to a particular load or a particular amount of stretching via movement of the gib slide 36. However, other load cells or load cell configurations may be used without departing from the scope of the technology described herein.

The load cell 18 may be mounted to a baseplate of the fixture 14 and/or a portion of the guideway 34 and may be positioned within the elongated opening 38 of the gib slide 36 such that the load cell spring attachment 22 position can be aligned within. 0.001″ diameter position to the slide spring attachment 20 (e.g., a polar oriented detented hook) to maintain the micro spring 30 in a vertical orientation, a horizontal orientation, or some other orientation in line with the linear movement of the gib slide 36. Specifically, the load cell 18 may be fixed to the fixture 14 (e.g., the frame) and/or the saddle or guideway 34 of the linear slide 12 and may be mounted through the elongated opening 38 of the gib slide 36 so as to minimize out-of-perfect linear movement effects on displacement measurements. For example, the load cell 18, as depicted in the figures, may be mounted to the fixture 14 and located through the elongated opening 38 of the gib slide 36 within a middle region of the elongated opening 38. For example, the middle region may be a region located at least 10%, 20%, 25%, or 30% of a length of the elongated opening 38 away from each of two opposing ends of the elongated opening 38. By being located in the middle region of the elongated opening 38 of the gib slide 36, this increases accuracy in case the gib slide 36 rotates around any axis within the guideway 34, creating less movement than if the load cell 18 were mounted at end regions of the elongated opening 38 or end regions of the gib slide 36 generally. In some embodiments, the linear slide 12 is mostly or entirely made of hardened ground steel components with 0.0001 to 0.0002 inches of clearance in any direction, so that the gib slide 36 is resistant to most movement other than the linear sliding performed thereby. For example, clearance between the guideway 34 and opposing front and back faces of the gib slide 36 may be 0.0001 inches to 0.0002 inches and clearance between the guideway 34 and opposing side edges of the gib slide 36 may be 0.0001 inches to 0.0002 inches.

The slide spring attachment 20 may be any mechanical attachment for selectively attaching one end of the micro spring 30 to the gib slide 36. The slide spring attachment 20 may be, for example, a single piece hook and in some embodiments may include selective orientation between a 0-degrees orientation and a 90-degrees orientation for proper alignment based on the micro spring's configuration. For example, an orientation device may manually rotate the slide spring attachment 20 between two or more rotational alignment orientations. The slide spring attachment 20 or the hook associated therewith may be used to hang the micro spring 30 therefrom at a top of the micro spring 30. In some embodiments, a spring connection to an indicator side of the inspection device 10 may be a head pin through a bushing, or a set of pre-loaded bearings, with a detented spring attachment to orient the spring attachment hook in a known polar orientation. In some embodiments, the hook of the slide spring attachment 20 is sized to a web diameter that is 3-5 times as large as the diameter of the wire forming the micro spring 30 and a loop diameter that is 8-10 times as large as the same wire.

The load cell spring attachment 22 may be a clevis with a pin extending through two protrusions a small space apart from each other. The load cell spring attachment 22 may, via the pin, connect a bottom of the micro spring 30 to the load cell 18. Furthermore, in order to attach the bottom of the micro spring 30 to the load cell 18, an on-center fixed pin may connect to an open-end micro spring's hook at the bottom or otherwise to an end opposite the end of the micro spring 30 attached to the gib slide 36 via the slide spring attachment 20.

The spacing for the cross-pin in the load cell spring attachment 22 assists in consistent and accurate measurements for the inspection device 10. Specifically, the clevis spacing for the cross-pin to extend through allowed the micro spring 30 to move a little bit or lay where it landed when it is connected. Other methods of restraint for that end of the micro spring 30 do not allow for identical positioning every time the micro spring 30 is measured, so then a different load measurement can unintentionally result. The width of the spacing between the clevis where the cross-pin of the load cell spring attachment 22 extends is 3 to 5 times as wide as the spring diameter (e.g., 0.015 to 0.016 inches width for the space, versus wire diameter of less than 0.005 inches).

The linear measurement device 26 and/or the linear measurement indicator shaft 24 may be positioned to sit on top of the slide spring attachment 20, and that linear measurement indicator shaft 24 or other such linear measurement device thus is used to indicate where the hook or the slide spring attachment 20 is in space (e.g., how far it has traveled from point a to point b in space). The measurements from the linear measurement indicator shaft 24 may then be communicated to the linear measurement indicator 26. The linear measurement indicator shaft 24 may be part of the linear measurement indicator 26 and may be an encoder, a Linear Variable Displacement Transducer (LVDT), or an indicator of any kind, as long as said indicator is accurate (estimating within +/−0.0001″) with a low uncertainty. One example linear measurement indicator 26 or linear measurement device is accurate within +/−0.00006 inches.

The linear measurement indicator 26 may be communicably coupled with the linear measurement indicator shaft 24 and may also be referred to herein as a displacement measuring indicator. The linear measurement indicator 26 senses the measured movement of the gib slide 36, which is how the inspection device 10 determines the extension length the micro spring 30 has been stretched (e.g., using raw data from the linear measurement indicator shaft 24 and/or calibration data as later described herein). At least one processor associated with the linear measurement indicator 26 may receive and output to a user interface (e.g., a display associated with the linear measurement indicator), or an external system for use thereby, the extension length of the micro spring 30. The linear measurement indicator 26 may be mounted to other components of the inspection device 10 such as the fixture 14 or frame and may, in some embodiments, communicate with the load cell readout 28 attached thereto. Additionally or alternatively, the linear measurement indicator 26 may include a communication device that transmits (via wired or wireless communication devices) displacement or position measurements to another processor, user interface, or external system or display (e.g., a smart phone, tablet, or computer screen).

The inspection device 10 (also referred to herein as a gauge) maintains a repeatable position accuracy to repeat zero hook-to-pin displacement within 0.0001″, with, for example, a 0-30 gram or a 0-50 gram load cell. However, other load cells may be used without departing from the scope of the disclosure herein. The linear measurement indicator 26 may be utilized to identify the clevis hook-to-fixed-pin zero position at a given tension or compression on the load cell 18. For example, when the hook web thickness of the slide spring attachment 20 and the pin diameter of the load cell spring attachment 22 are known, the position can be set by knowing when the hook of the slide spring attachment 20 is lowered down to touch the pin of the load cell spring attachment 22 and fits therein, and then the position of the linear measurement indicator shaft 24 relative thereto is also known and is used to calibrate where that hook of the slide spring attachment 20 is in space. This then allows a determination of how far the micro spring 30 is pulled linearly during inspection. Additionally or alternatively, there may be a standard component of a known length may be attached between the slide spring attachment 20 and the load cell spring attachment 22 to obtain a reference point, such that the linear measurement indicator 26 can be calibrated as described herein.

The inspection device 10 may be used in either a vertical orientation or a horizontal orientation. The inspection device 20 may be set upright for spring testing, upside down for load cell calibration; or possible used horizontally, depending upon spring use. The load cell 18 may be calibrated while mounted to the fixture 14 of the inspection device 10. The fixtures and tight alignment control used in the inspection device 10 allow for more consistency in alignment, because small changes in alignment between the hooks supporting the ends of the micro spring 30 or any lash in the system can become critical to measurement accuracy for micro springs. This is due to how small micro springs are, such that micro springs can only handle such small loads that even the slightest of changes can have a huge effect on the outcome.

In some embodiments, the inspection device 10 may further include a processor (not shown) and/or memory configured to store and/or automatically perform any of the method steps described herein. For example, various calibration data and other settings of the inspection device 10 may be stored in the memory, and the processor may assist in outputting measurement or inspection data to a user interface such as a display of the linear measurement indicator 26 via one or more processors thereof or associated therewith, or a communication device that outputs such data to an external system such as another computer, tablet, smart phone, or handheld device or another external system that utilizes the data for other actions performed thereby.

The processor and/or the memory may be embodied by any one or more electronic devices, such as computer servers, workstation computers, desktop computers, laptop computers, palmtop computers, notebook computers, tablets or tablet computers, smartphones, mobile phones, cellular phones, or the like. Specifically, the processor may comprise one or more processors and may include electronic hardware components such as microprocessors (single-core or multi-core), microcontrollers, digital signal processors (DSPs), field-programmable gate arrays (FPGAs), analog and/or digital application-specific integrated circuits (ASICs), or the like, or combinations thereof. The processor may generally execute, process, or run instructions, code, code segments, code statements, software, firmware, programs, applications, apps, processes, services, daemons, or the like. The processor may also include hardware components such as registers, finite-state machines, sequential and combinational logic, configurable logic blocks, and other electronic circuits that can perform the functions necessary for the operation of the current invention. In certain embodiments, the processor may include multiple computational components and functional blocks that are packaged separately but function as a single unit. In some embodiments, the processor may further include multiprocessor architectures, parallel processor architectures, processor clusters, and the like, which provide high performance computing. The processor may be in electronic communication with the other electronic components through serial or parallel links that include universal busses, address busses, data busses, control lines, and the like. The processor may be operable, configured, or programmed to perform the method steps described later herein by utilizing hardware, software, firmware, or combinations thereof.

The processor may include and/or communicate with other processors, the memory, the user interface (or any displays or components thereof, and/or any external devices (e.g., another computer, smart phone, tablet of the like) via communication elements and/or user interfaces known in the art, such as keyboards, a mouse, a trackball, a touch screen, input ports, wireless communication devices, or the like configured to receiving input from a user. The user interface may also include a display, light indicators, speakers, or other components configured to output information to a user. Various communication elements may allow the exchange of data with other computing devices, external systems, networks, and the like. The communication element may include signal and/or data transmitting and receiving circuits, such as antennas, amplifiers, filters, mixers, oscillators, digital signal processors (DSPs), and the like. The communication element may establish communication wirelessly by utilizing radio frequency (RF) signals and/or data that comply with communication standards such as cellular 2G, 3G, 4G, Voice over Internet Protocol (VOIP), LTE, Voice over LTE (VOLTE), or 5G, Institute of Electrical and Electronics Engineers (IEEE) 802.11 standard such as WiFi, IEEE 802.16 standard such as WiMAX, Bluetooth™, or combinations thereof. In addition, the communication element may utilize communication standards such as ANT, ANT+, Bluetooth™ low energy (BLE), the industrial, scientific, and medical (ISM) band at 2.4 gigahertz (GHz), or the like. Alternatively, or in addition, the communication element may establish communication through connectors or couplers that receive metal conductor wires or cables which are compatible with networking technologies such as ethernet. In certain embodiments, the communication element may also couple with optical fiber cables.

The memory may be embodied by devices or components that store data in general, and digital or binary data in particular, and may include exemplary electronic hardware data storage devices or components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, solid state memory, or the like, or combinations thereof. In some embodiments, the memory may be embedded in, or packaged in the same package as, the processor. The memory may include, or may constitute, a non-transitory “computer-readable medium”. The memory may store the instructions, code, code statements, code segments, software, firmware, programs, applications, apps, services, daemons, or the like that are executed by the processor. The memory may also store data that is received by the processor or the device in which the processor is implemented. The processor may further store data or intermediate results generated during processing, calculations, and/or computations as well as data or final results after processing, calculations, and/or computations. In addition, the memory may store settings, data, documents, curing models, other statistical models, layup models, production models, other instructions, photographs, videos, images, databases, and the like.

In some embodiments, the memory may be configured to store calibration data, micro spring characteristics, and/or any software instructions utilizing the measurements from the inspection device as described above for output to a user via the linear measurement indicator, the load cell readout, or remote devices in communication with various sensors or electronic components of the inspection device as described herein. To account for compliance (e.g., how far the load cell's smaller box moves), linear measurements can be accounted for through software or estimated based on load cell compliance calibration. Load cell compliance may involve interpolating based on linear calibration or estimating based on a range in which the measurement is taken.

To calibrate the load cell 18, the fixture 14 and/or a base plate thereof and the shafts (e.g., the guide shafts) may stay fixed, but the load cell readout 28 and/or the linear measurement indicator 26 may be removed, and the entire remaining components of the inspection device 10 may be flipped upside down to calibrate the load cell 18 and leave the load cell 18 on the fixture 14. Calibration weights (not shown) can be hung from the load cell 18 (e.g., from the load cell attachment 22) while the load cell 18 is mounted on the fixture 14 and remaining in its upside-down orientation. However, other calibration methods may be used without departing from the scope of the invention as described herein. Such calibration is then used to estimate how far the load cell 18 deflects when pulled on by the micro spring 30 via interpolation or the like.

For example, if the load cell is calibrated and it is thus known (or determined via interpolation or estimation based on the calibration values) how far the load cell's smaller box moves or deflects within the larger box for each of a plurality of loads (e.g., stored in the memory during calibration), the user or the processor described herein can adjust the amount of micro spring stretch measured via the linear measurement indicator 26 to account for that deflection of the smaller box in the load cell 18. This compensation for compliance can improve the accuracy of the measurements provided by the linear measurement indicator 26. In yet another specific example, to get an exact load value at an exact distance, the inspection device 10 in some embodiments may interpolate the distance value, because the slide spring attachment 20 was pulled 0.200 of an inch in one example embodiment and the load cell 18 deflected in the same direction by 0.002 of an inch, so it really only stretched the micro spring 0.198 of an inch. However, if the load cell 18 is calibrated and it is known how far it moves (e.g., 0.002 inches) under each load, a slope or line can be created to interpolate the actual value based on that calibration data.

In general, operation of the inspection device 10 described above involves manually moving the linear slide 12 or slide gib 36 of the guideway 34 that is connected to the slide spring attachment 20. The slide spring attachment 20 is connected to one end of a micro spring 30 and the load cell 18 is connected at an opposite end of the micro spring 30 via the load cell attachment 22. The inspection device 10 measures how far the linear slide 12 or the slide gib 36 thereof (which is attached to the slide spring attachment 20) moves while pulling on the micro spring 30 via a lateral movement of the slide gib 36. In some embodiments, a one-ounce or two-ounce load cell may be used for accuracy of the measurements described herein. However, other load cells may be used depending upon the micro spring's material, dimensions, and accuracy requirements needed for a given micro spring. The inspection device 10 connects both ends of the micro spring 30 and gives a consistent reading beyond any other prior art spring measurement methods or devices in the prior art. The inspection device 10 has shown consistency to predict how micro springs will react. The load cell 18 can be calibrated and using the techniques and the inspection device 10 herein, the load can be estimated within 0.001 ounces of accuracy.

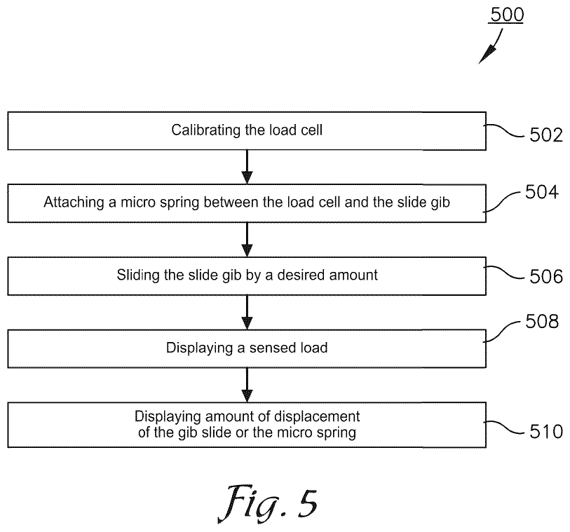

Steps for an exemplary method of measuring micro extension springs as part of an inspection process (e.g., using the inspection device 10) will now be described in more detail, in accordance with various embodiments of the present invention. The operations of method 500 may be performed in the order as shown in FIG. 5, or they may be performed in a different order. Furthermore, some operations may be performed concurrently as opposed to sequentially. In addition, some operations may not be performed.

In one or more embodiments, the method 500 may include calibrating the load cell 18, as depicted in block 502. This calibration may comprise calibrating a zero hook-to-pin location of the linear measurement indicator shaft 24. Specifically, the linear measurement indicator 26 may be utilized to identify the clevis hook-to-fixed-pin (or load cell spring attachment to slide spring attachment) zero position at a given tension or compression on the load cell 18. For example, the position can be set by knowing when the hook of the slide spring attachment 20 is lowered down to touch the pin of the load cell spring attachment 22 and fits therein, then the position of the linear measurement indicator shaft 24 relative thereto is known, stored in the memory, and used to calibrate where that hook of the slide spring attachment 20 is in space. Additionally or alternatively, as described above, a standard component of a known length may be attached between the slide spring attachment 20 and the load cell spring attachment 22 to obtain a reference point, such that the linear measurement indicator 26 can be calibrated. For example, pre-determined load cell compliance generates a slope of which the coupler is used to return to a location on the slope to then set the linear measurement indicator 26 position in space. This then allows the processor to utilize this information to determine how far the micro spring 30 is pulled linearly during inspection. The calibration may also comprise hanging weights from the load cell spring attachment 22 to determine amounts of deflection for each of a plurality of known loads. For example, in some embodiments, to calibrate the load cell 18, the load cell readout 28 and/or the linear measurement indicator 26 may be removed, and the entire remaining components of the inspection device 10 may be flipped upside down to calibrate the load cell 18. Calibration weights (not shown) can be hung from the load cell 18 while the load cell 18 is mounted on the fixture 14 and remaining in its upside-down orientation. However, other calibration methods may be used without departing from the scope of the invention as described herein. Such calibration is then used to estimate how far the load cell 18 deflects when pulled on by the micro spring 30 via interpolation or the like, as described above. Such calibration data may be stored in the memory for later calculations, interpolations, and/or estimations to compensate for the deflection of portions of the load cell 18 during use at different loads. Furthermore, note that load compliance may also be determined prior to setting the position of the load measurement indicator 26. Also note, the load cell 18 may be exercised the same way prior to load cell calibration, load cell compliance, indicator preset position, and micro spring measurement.

In yet another embodiment, the method 500 may include a step of attaching a micro spring to the inspection device 10, as depicted in block 504. This may include reorienting the slide spring attachment 20 (e.g., a hook) from a first rotational orientation to a second rotational orientation (e.g., zero degrees to 90 degrees or vice versa). This may be performed to accommodate for micro springs having different lengths or end hooks or loops ending in different orientations. Furthermore, this attaching step may in some embodiments include actuating the slide position fine adjustment mechanism 16, such as rotating a knob thereon, to fine tune the linear position of the slide gib 36 to accommodate for different lengths of the micro spring 30.

Furthermore, the method 500 may include a step of moving or sliding the linear slide 12 or slide gib 36 by a desired amount, as depicted in block 506. This sliding may be achieved via an actuator and/or manually by an operator of the inspection device 10, with the desired amount, once achieved by the movement of the slide gib 36, being provided on a display or user interface of the linear measurement indicator 26 via the one or more processors thereof and/or otherwise used or indicated by an external system. The slide spring attachment 20 is connected to one end of the micro spring 30 and the load cell 18 is connected at an opposite end of the micro spring 30 via the load cell spring attachment 22. The inspection device 10 measures how far the linear slide 12 or the slide gib 36 thereof (which is attached to the slide spring attachment 20) moves while pulling on the micro spring 30 via a lateral movement of the slide gib 36.

In one or more embodiments, the method 500 may also include a step of displaying a sensed load on the load cell readout 28 received from the load cell 18, as depicted in block 508, and may further include displaying slide gib 36 displacement and/or micro spring extension length (e.g., a distance the micro spring is stretched) on a display of the linear measurement indicator 26, as depicted in block 510. The amount displayed on the load cell readout 28 may, in some embodiments, be based on raw data from the load cell 18 and/or may be based on calibration data obtained during the calibration steps described above. Likewise, the value displayed on the display of the linear measurement indicator 26 may use raw data from the linear measurement indicator shaft 24 and/or calibration data stored in memory and/or otherwise obtained during the calibration steps described above. In some embodiments, the linear measurement indicator's display and the load cell readout 28 may be a single display displaying some or all of the values measured and described herein. Additionally or alternatively, the linear measurement indicator 26 and/or the load cell 18 may include a communication devices that transmit (via wired or wireless communication devices) load, displacement, or position measurements to a remote display (e.g., a smart phone, tablet, or computer screen). For example, in some embodiments described herein, the steps depicted in 508 and 510 may be replaced with one or more processors receiving load output from the load cell and distance output from the sensor and outputting at least one of a load associated with the load output and a distance associated with the distance output to a user interface or an external system. The user interface may include the displays of the load cell readout 28 and the linear measurement indicator 26, or may include speakers, indicator lights, or any other user interface known in the art for indicating information to a user and/or receiving information from a user. The external system may include smart phones, tablets, computers, and/or other systems configured to utilize the load and distance data transmitted thereto.

Advantageously, the inspection device 10 connects both ends of the micro spring 30 and gives a consistent reading beyond any other prior art spring measurement methods or devices in the prior art. The inspection device 10 has shown consistency to predict how micro springs will react. The load cell 18 can be calibrated and using the techniques and the inspection device 10 herein, the load can be estimated within 0.001 ounces of accuracy. As noted above, although the inspection device 10 and the methods herein are described in as moving to a known displacement and determining the load, the inspection device can control for either displacement or load in order to get the other. That is, a known load can be applied and the indicator 26 can determine the displacement experienced without departing from the scope of the technology described herein.

### Additional Considerations

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processor may comprise dedicated circuitry or logic that is permanently configured, such as an application-specific integrated circuit (ASIC), or indefinitely configured, such as an FPGA, to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processing elements need not be configured or instantiated at any one instance in time. For example, where the processor comprises a general-purpose processor configured using software, the general-purpose processor may be configured as respective different processing elements at different times. Software may accordingly configure the processor to constitute a particular hardware configuration at one instance of time and to constitute a different hardware configuration at a different instance of time.

Computer hardware components, such as communication elements, memory or memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory or memory device to which it is communicatively coupled. A further computer hardware component may then, at a later time, access the memory to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processors or processing element-implemented hardware modules. The performance of certain of the operations may be distributed among the one or more processing elements or processors, not only residing within a single machine, but deployed across a number of machines. In some example embodiments, the processor or processing elements may be located in a single location (e.g., within a home environment, an office environment or as a server farm), while in other embodiments the processor or at least some of its processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed, and substitutions made herein, without departing from the scope of the technology as recited in the claims.

1. An inspection device for measuring micro spring tension, the inspection device comprising:
a guideway;
a slidable plate slidably positioned within the guideway and having an elongated opening formed therethrough, wherein the slidable plate is configured to slide back and forth along a single axis of movement;
a load cell fixed relative to the guideway and extending through the elongated opening of the linearly slidable plate;
a slide spring attachment fixed to the linearly slidable plate;
a load cell spring attachment fixed to the load cell and spaced a distance away from the slide spring attachment such that opposing ends of the micro spring are attachable between the slide spring attachment and the load cell spring attachment;
a sensor sensing movement along the single axis of the linearly slidable plate; and
one or more processors configured for receiving load output from the load cell and distance output from the sensor and outputting at least one of a load associated with the load output and a distance associated with the distance output to a user interface or an external system.

2. The inspection device of claim 1, wherein the slidable plate is selectively moveable along the single axis by a slide position fine adjustment mechanism.

3. The inspection device of claim 1, wherein the load cell is located through the elongated opening in a middle region of the elongated opening, wherein the middle region is at least 10%, 20%, 25%, or 30% of a length of the elongated opening away from opposing ends of the elongated opening.

4. The inspection device of claim 1, wherein at least one of the guideway and the slidable plate is steel.

5. The inspection device of claim 1, wherein clearance between the guideway and opposing front and back faces of the slidable plate is 0.0001 inches to 0.0002 inches and clearance between the guideway and opposing side edges of the slidable plate is 0.0001 inches to 0.0002 inches.

6. The inspection device of claim 1, wherein at least one of the slide spring attachment and the load cell spring attachment is a hook selectively oriented between at least two different rotational orientations.

7. The inspection device of claim 1, further comprising a micro spring having opposing ends formed into hooks or loops, wherein the opposing ends are attached to the slide spring attachment and the load cell spring attachment respectively.

8. An inspection device for measuring micro spring tension, the inspection device comprising:
a guideway;
a linearly slidable plate slidably positioned within the guideway and having an elongated opening formed therethrough;
a load cell fixed relative to the guideway and extending through the elongated opening of the linearly slidable plate;
a slide spring attachment fixed to the linearly slidable plate;
a load cell spring attachment fixed to the load cell, wherein the load cell spring attachment and the slide spring attachment are each configured for attaching to opposing ends of the micro spring;
a linear measurement indicator shaft sensing relative linear movement of the linearly slidable plate or the slide spring attachment; and
one or more processors configured for receiving signals from the load cell and the linear measurement indicator and outputting at least one of a load associated with signals from the load cell and a distance associated with signals from the linear measurement indicator shaft to a user interface or an external system.

9. The inspection device of claim 8, wherein the linearly slidable plate is selectively moveable linearly by a slide position fine adjustment mechanism.

10. The inspection device of claim 8, wherein the load cell is located through the elongated opening in a middle region of the elongated opening, wherein the middle region is at least 10%, 20%, 25%, or 30% of a length of the elongated opening away from opposing ends of the elongated opening.

11. The inspection device of claim 8, wherein at least one of the guideway and the linearly slidable plate is steel.

12. The inspection device of claim 8, wherein the guideway comprises a pair of guide shafts with linear bearings that flank the load cell.

13. The inspection device of claim 8, wherein clearance between the guideway and opposing front and back faces of the linearly slidable plate is 0.0001 inches to 0.0002 inches and clearance between the guideway and opposing side edges of the linearly slidable plate is 0.0001 inches to 0.0002 inches.

14. The inspection device of claim 8, wherein the slide spring attachment is a hook selectively oriented between at least two different rotational orientations.

15. The inspection device of claim 1, further comprising a micro spring having opposing ends formed into hooks or loops, wherein the opposing ends are attached to the slide spring attachment and the load cell spring attachment.

16. An inspection method for measuring micro spring tension with an inspection device, the inspection method comprising:
attaching a micro spring between a linearly slidable plate and a load cell, wherein the linearly slidable plate is slidable relative to a steel guideway and has an elongated opening formed through the linearly slidable plate and the load cell is fixed relative to the guideway and extends through the elongated opening;
linearly sliding the linearly slidable plate away from the load cell, stretching the micro spring;
receiving from a linear measurement indicator shaft a measurement corresponding to an amount of relative linear movement of the linearly slidable plate;
receiving from the load cell a load cell output; and
displaying at least one of the relative linear movement and the load cell output on at least one display.

17. The inspection method of claim 10, wherein linear sliding of the linearly slidable plate is performed by actuating a slide position fine adjustment mechanism.

18. The inspection method of claim 10, wherein the micro spring is attached to the linearly slidable plate by a selectively rotatable hook, wherein the method further comprises reorienting the hook from a first rotational orientation to a second rotational orientation.

19. The inspection method of claim 10, further comprising calibrating the load cell or a processor associated with the load cell by hanging one or more weights from a load cell spring attachment attached to the load cell.

20. The inspection method of claim 10, further comprising calibrating a processor associated with the at least one display by attaching a component of known length between a slide spring attachment attached to the linearly slidable plate and a load cell spring attachment attached to the load cell and storing a position of the linear measurement indicator shaft's position in space in a memory accessible by the processor for determining the amount of relative linear movement of the linearly slidably plate.
